(19) United States
(12) Patent Application Publication
(10) Pub. No.: US 2026/0089106 A1
(43) Pub. Date: Mar. 26, 2026

(54) OPTIMIZING SELECTION OF FLOWS TO REROUTE

(71) Applicant: Hewlett Packard Enterprise Development LP, Spring, TX (US)

(72) Inventors: Duncan Roweth, Bristol (GB); Jonathan P. Beecroft, Bristol (GB); David Charles Hewson, Bristol (GB); Abdulla M. Bataineh, Vista, CA (US)

(21) Appl. No.: 18/895,075

(22) Filed: Sep. 24, 2024

(51) Int. Cl. H04L 47/122; H04L 43/0882; H04L 45/302; H04L 47/2483

(52) U.S. Cl. CPC H04L 47/122; H04L 43/0882; H04L 45/304; H04L 47/2483

(57) ABSTRACT

A system generates, by a network device operating as an intermediate network device, a load metric for a respective flow of a first set of received flows. The system sends, to a first ingress network device, a redirect acknowledgment (ACK) including the load metric for the respective flow in response to the load metric being greater than a load value. The system forwards, by the network device operating as a second ingress network device, a second set of flows. The system receives, from a plurality of intermediate network devices, redirect ACKs corresponding to a plurality of flows of the second set of flows. A respective redirect ACK includes a load metric for a corresponding flow of the plurality of flows. The system selects, from the flows based on a set of rerouting conditions, a first flow to be rerouted. The system reroutes the first flow to a new path.

### STATEMENT OF GOVERNMENT-FUNDED RESEARCH

This application was made with Government support under Contract number H98230-15-D-0022/0003 awarded by the Maryland Procurement Office. The Government has certain rights in this invention.

### BACKGROUND

A network fabric may include ingress network devices, intermediate or “mid-point” network devices, and egress network devices. Paths through the network fabric for ordered flows may be selected based on load. Some flows, such as persistent flows, may result in a load imbalance over time, and some paths may be more heavily used than others. Congestion may be detected by a mid-point network device when a packet for a flow is received. The mid-point network device can relay the detected “mid-point congestion” to the ingress network device and allow the ingress network device to reroute the flow to a new path. However, rerouting flows may affect the cost and efficiency of the network fabric.

### BRIEF DESCRIPTION OF THE FIGURES

FIG. 1 illustrates an environment which facilitates optimizing selection of flows to reroute, in accordance with an aspect of the present application.

FIG. 2 illustrates an environment which facilitates optimizing selection of flows to reroute, in accordance with an aspect of the present application.

FIG. 3A presents a flowchart illustrating a method which facilitates optimizing selection of flows to reroute, including a network device operating as an intermediate network device, in accordance with an aspect of the present application.

FIG. 3B presents a flowchart illustrating a method which facilitates optimizing selection of flows to reroute, including a network device operating as an ingress network device, in accordance with an aspect of the present application.

FIG. 3C presents a flowchart illustrating a method which facilitates optimizing selection of flows to reroute, including pausing a flow which may be rerouted, in accordance with an aspect of the present application.

FIG. 3D presents a flowchart illustrating a method which facilitates optimizing selection of flows to reroute, including rerouting a flow, in accordance with an aspect of the present application.

FIG. 4 illustrates a computer system which facilitates optimizing selection of flows to reroute, in accordance with an aspect of the present application.

FIG. 5 illustrates a computer-readable medium which facilitates optimizing selection of flows to reroute, in accordance with an aspect of the present application.

In the figures, like reference numerals refer to the same figure elements.

### DETAILED DESCRIPTION

Aspects of the present application provide a system which facilitates optimizing the selection of flows to reroute, including whether or not to reroute a flow. The system can be based on congestion detected by a mid-point network device and congestion managed by an ingress network device.

A network fabric may include ingress network devices, intermediate network devices, and egress network devices. Paths through the network fabric for ordered flows may be selected based on load. A flow may follow the same selected path while data is pending in the network fabric. Some flows, such as persistent flows which continue for a long period of time, may result in a load imbalance over time, e.g., the load may change over time, while some paths may be more heavily used than others.

Congestion may occur in the middle of the network fabric (i.e., “mid-fabric congestion” or “mid-point congestion” detected by an intermediate or mid-point network device) or at an egress of the network fabric (i.e., “endpoint congestion” detected by an egress or endpoint network device) when a packet for a flow is received. Too many flows may be attempting to share the same link, which can result in excess packets which are waiting in a queue to be given their share of the bandwidth of the link. Rerouting a flow that encounters endpoint congestion and which has already reached the egress network device may not provide benefits. In contrast, rerouting a flow that encounters mid-fabric congestion may result in an improvement in the overall efficiency of the network fabric because the rerouted flow will likely be directed onto a different mid-fabric link with fewer flows and spare bandwidth to take more packets. Mid-point congestion can be detected by a mid-point network device when a packet for a flow is received, and the mid-point network device may relay the detected mid-point congestion to the ingress network device and allow the ingress network device to reroute the flow to a new path. However, rerouting flows may affect the cost and efficiency of the network fabric.

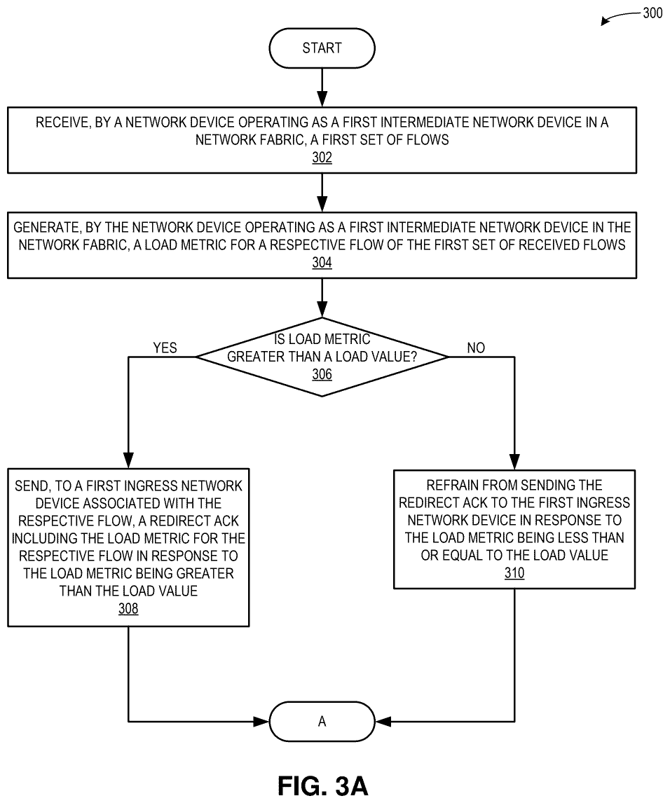

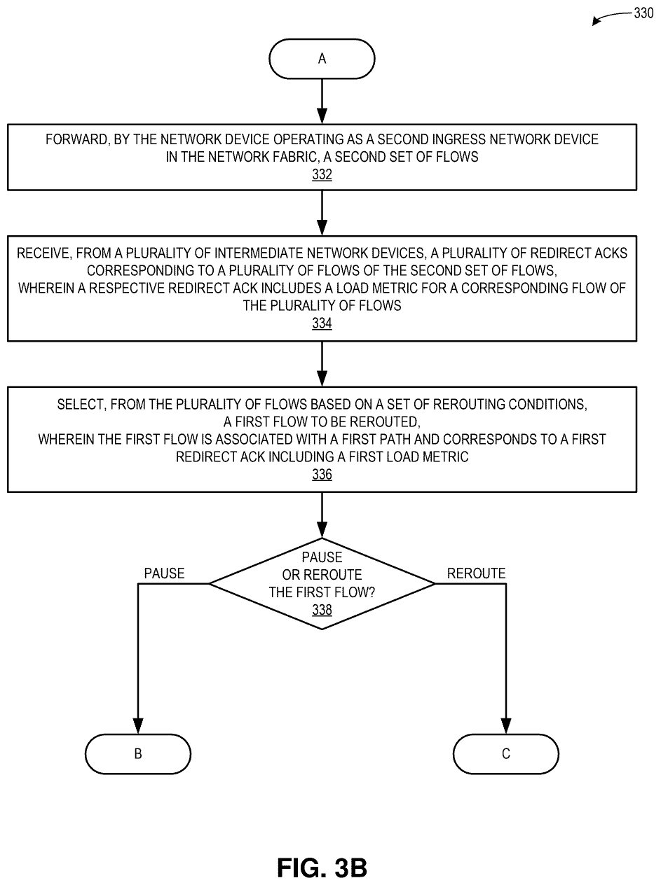

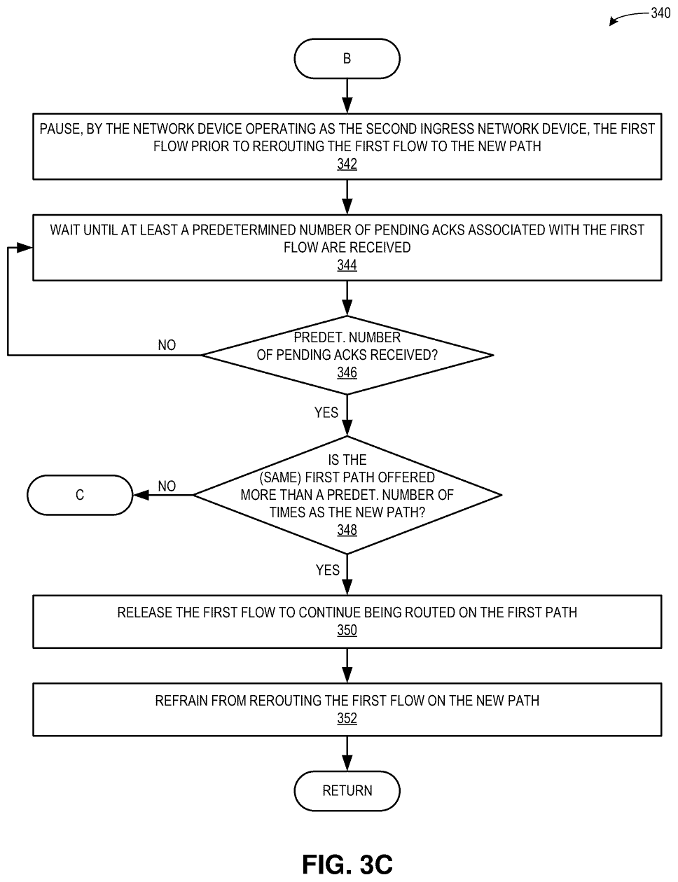

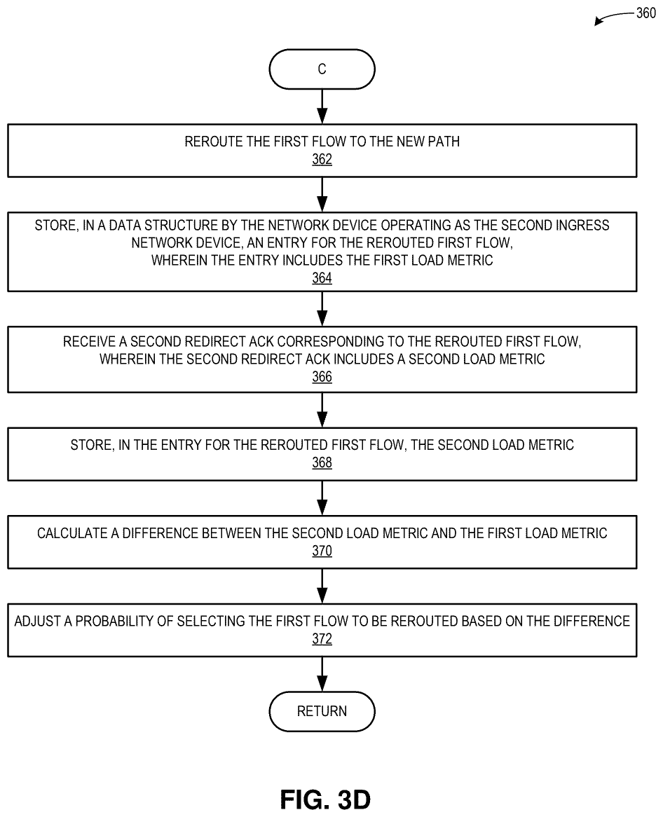

The described aspects provide a system which facilitates optimizing the selection of flows to reroute, based on congestion detected by a mid-point network device and congestion managed by an ingress network device. A mid-point network device can detect congestion associated with a received flow sent by an ingress network device (i.e., mid-point congestion) when a packet for a flow is received. The mid-point network device can generate a load metric for the received flow. The load metric may be based on various parameters, e.g., bandwidth consumption of all flows entering the mid-point network device and the size of a packet in a particular flow. If the load metric is greater than a predetermined or preconfigured load value, the mid-point network device can return to the ingress network device a “redirect acknowledgment (ACK)” which includes the generated load metric. Determining whether to generate and send a redirect ACK is described below in relation to, e.g., FIG. 3A.

Upon receiving multiple redirect ACKs corresponding to multiple flows, the ingress network device can select a flow (corresponding to an original path) to be rerouted. The ingress network device can optimize the selection of the flow to be rerouted based on several techniques. In one technique, the ingress network device can stop and “drain” the selected flow, i.e., wait for pending ACKs to be returned. While waiting for the selected flow to drain, if the original path is offered as the path for rerouting the flow more than a certain number of times, the ingress network device can release the flow and simply use the original path. In some aspects, the ingress network device may release the flow to a next-hop network device on the original path, but the next-hop network device may still wait for the flow to drain before selecting a different path. Otherwise, the ingress network device can reroute the flow onto a new path.

In another technique, the ingress network device can store the load metric included in the redirect ACK corresponding to a flow (e.g., the rerouted flow). If a second redirect ACK is received by the ingress network device from that same flow (e.g., the rerouted flow) on the new path, the ingress network device can store the load metric included in the second redirect ACK. The ingress network device may subsequently use the stored information to determine whether to select the flow for rerouting or whether to perform another reroute operation on the rerouted flow.

In another technique, the ingress network device may base the decision on whether to select a flow for rerouting on various rerouting conditions, including but not limited to, e.g.: an amount of time that has passed since a most recently rerouted flow; an amount of data pending to be sent in a respective flow; a comparison of the stored load metric of the respective flow to the load metrics of the other flows; and the difference, if available, between the stored load metrics of redirect ACKs received corresponding to the same flow.

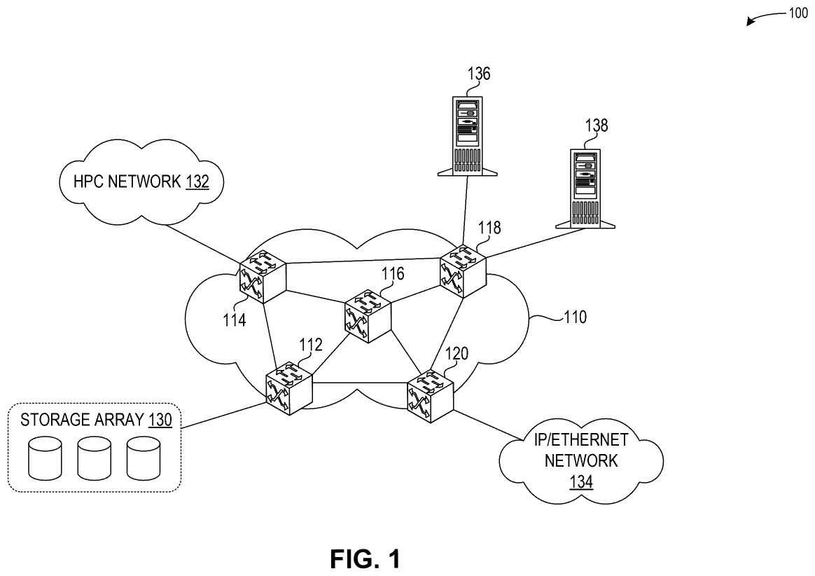

FIG. 1 illustrates an environment 100 which facilitates optimizing selection of flows to reroute, in accordance with an aspect of the present application. Environment 100 can include a network 110 of switches which can be referred to as a “switch fabric” and can include switches 112, 114, 116, 118, and 120. Each switch can have a unique address or identifier within switch fabric 110. Various types of endpoints, processing nodes, devices, and networks can be coupled to a switch fabric. For example, a storage array 130 may be coupled to switch fabric 110 via switch 112; a high performance computing (HPC) network (e.g., InfiniBand, Slingshot, or any other high performance network) 132 may be coupled to switch fabric 110 via switch 114; a number of end hosts, such as hosts 136 and 138, may be coupled to switch fabric 110 via switch 118; and an Internet Protocol (IP)/Ethernet network 134 may be coupled to switch fabric 110 via switch 120. HPC network 132 may include multiple networked computer and storage devices concurrently running programs to complete different complex and performance-intensive tasks. IP/Ethernet network 134 may include physical Ethernet cabling and an application layer protocol between network devices based on IP, including communication via Transport Communication Protocol (TCP)/IP and User Datagram Protocol (UDP) packets. Switch fabric 110 may itself be an Ethernet network or an HPC network.

In general, a switch can have edge ports and fabric ports. An edge port can couple to a device that is external to the fabric. A fabric port can couple to another switch within the fabric via a fabric link. Typically, traffic may be injected into switch fabric 110 via an ingress port of an edge switch and may leave switch fabric 110 via an egress port of another (or the same) edge switch. An ingress link can couple a network interface controller (NIC) of an edge device (e.g., an HPC end host) to an ingress edge port of an edge switch. Switch fabric 110 can then transport the traffic to an egress edge switch, which in turn can deliver the traffic to a destination edge device via another NIC. A packet can be forwarded in switch fabric 110 based on its Layer-2 address (“fabric address”), which may be viewed as an equivalent to a media access control (MAC) address in Ethernet. The forwarding path for the packet may be determined based on adaptive forwarding, e.g., based on local programming of the switches in switch fabric 110 and information related to load, traffic, and congestion available to and associated with switch fabric 110.

In some aspects, switch fabric 110 or HPC network 132 may include network devices (i.e., switches) including ingress network devices, intermediate or mid-point network devices, and egress or endpoint network devices. A switch in switch fabric 110 may include systems which perform operations associated with an ingress network device, an intermediate network device, and an egress network device. For example, switch 118 may be an ingress network device for data originating from device 136 and destined for IP/Ethernet network 134 (with switch 120 as the egress network device for such data), and switch 118 may also be an egress network device for data originating from IP/Ethernet network 134 and destined for device 136 (with switch 120 as the ingress network device for such data). In addition, a switch in switch fabric 110 may also include systems which perform operations associated with mid-point network devices. For example, switch 118 may be an intermediate network device for data originating from IP/Ethernet 134 and destined for HPC network 132, e.g., via a possible path which includes switch 120 (acting as an ingress network device), switch 118 (acting as an intermediate network device), and switch 114 (acting as an egress network device). Thus, a single switch may include systems which perform functionality relating to an ingress network device, an intermediate network device, and an egress network device.

As another example, data traveling from IP/Ethernet network 134 (“source”) to HPC network 132 (“destination”) may enter switch fabric 110 via ingress network device 120 and travel via intermediate network device 116 to egress network device 114. Based on this data traveling from the source to the destination, switch 116 may receive a first set of flows and generate a load metric for each flow. The load metric may be based on a current load associated with switch 116 and determined based on, e.g., a depth of an output queue on switch 116 which stores pending packets waiting to be transmitted. The load may be expressed as an explicit congestion avoidance (ECA) value. The ECA may include a certain number of bits (e.g., 11 bits) and may indicate a level or severity of congestion on the link as determined by switch 116 at a mid-point of network fabric 110. The ECA may be an input which is used to determine whether an ACK should be generated. The current load associated with switch 116 may also be based on a size of a packet in a given flow of the first set of received flows. Furthermore, the decision to generate a redirect ACK associated with switch 116 may be based on a product of the load and the packet size. In some aspects, the load metric may be based on, e.g.: bandwidth consumption associated with the detecting switch or network device; an amount of data pending in an input buffer associated with the detecting switch or network device; information received from a NIC and associated with an amount of data pending to be processed by detecting switch or network device; and information associated with a state of a respective flow (e.g., a flow of the first set of flows received by intermediate network device 116 or a flow of a second set of flows forwarded by switch 120). Other metrics may also be used to determine whether or not to send the redirect ACK.

Switch 116 can determine whether a load metric for a respective flow of the first set of flows is greater than a predetermined load value. The predetermined load value may be a randomly generated number, another number, or a threshold. The predetermined load value may be selected or preconfigured by the system or an administrative user associated with network fabric 110 or switch 116. If the load metric is greater than the predetermined load value, switch 116 can send, to ingress network device 120, a redirect ACK including the generated load metric for the respective flow. If the load metric is less than the predetermined load value, switch 116 can refrain from sending the redirect ACK to ingress network device 120. In some aspects, switch 116 may compare the load metric to the predetermined load value in response to the load metric being greater than a predetermined threshold, e.g., a preliminary or initial threshold.

Switch 120 (operating as an ingress network device in the continuing example depicted in environment 100) can forward a second set of flows, including flows destined for HPC network 132 via switch 114 (operating as an egress network device). The second set of flows may be forwarded through network fabric 110, including through switch 116 (operating as an intermediate network device) and through switch 118 (also operating as an intermediate network device). The intermediate network devices which receive the second set of flows may detect mid-point congestion when a packet for a flow is received and send redirect ACKs which include a load metric for a corresponding flow. Switch 120 can receive, from a plurality of intermediate network devices, such as switches 116 and 118, the redirect ACKs corresponding to a plurality of flows in the second set of flows.

Switch 120 can select, from the plurality of flows corresponding to the received redirect ACKs (which indicate mid-point congestion), a first flow to be rerouted. The first flow may be associated with a first path and may correspond to a first redirect ACK including a first load metric. Selecting the first flow to be rerouted may be based on a set of rerouting conditions, including but not limited to, e.g.: an amount of time that has passed since a most recently rerouted flow; an amount of data pending to be sent in a respective flow of the plurality of flows; a comparison of the load metric of the respective flow of the plurality of flows to load metrics of other flows in the plurality of flows; or a difference, if available, between load metrics included in redirect ACKs received corresponding to a same flow. The set of rerouting conditions may be associated with a probability of a respective flow from the plurality of flows being selected to be rerouted. The probability may increase based on an increase in the load (e.g., an increasing ECA value returned in the redirect ACK) or an increase in the packet size. For example, the system may select the first flow to be rerouted by using a probabilistic model based on the ECA value.

Switch 120 can reroute the first flow to a new path and can also store, in a data structure, an entry for the rerouted first flow. The entry may include the first load metric. In some aspects, subsequent to rerouting the first flow, switch 120 may receive a second redirect ACK corresponding to the rerouted first flow. The second redirect ACK may be sent by an intermediate network device and can include a second load metric. Switch 120 can store the second load metric in the entry for the rerouted first flow. In determining whether to select the flow again for rerouting, switch 120 can determine a difference between the second load metric and the first load metric. Switch 120 can adjust a probability of selecting the first flow to be rerouted based on the difference. For example, a small difference (i.e., less than a first predetermined value) may indicate that congestion has not improved on the new path for the first rerouted flow and that the first flow may be a candidate to be selected for rerouting. On the other hand, a large difference (i.e., greater than a second predetermined value) may indicate that congestion has improved on the new path and that rerouting the flow may be less beneficial. As a result, the probability that the first flow is to be selected for rerouting may be adjusted by the ingress network device.

Prior to rerouting the first flow, switch 120 can also pause the first flow and initiate a waiting period. For example, switch 120 may wait until the first flow has “drained,” i.e., until switch 120 has received a predetermined number of pending ACKs associated with the first flow. During the pause or waiting period, switch 120 may “repeatedly” offer the original path for the first flow. For example, if switch 120 offers the original path more than a predetermined number of times (e.g., 10 times) or more than a predetermined rate (e.g., 5 times in 5 milliseconds) during a certain time period (e.g., the most recent 10 milliseconds), switch 120 may determine to release the first flow to continue being routed on the first path. Thus, in some circumstances, switch 120 may refrain from rerouting the first path. The circumstances of the “repeated” offerings described above are provided as illustrative examples only. Other metrics may be used as the threshold for determining repeated offerings which trigger a release of the first flow.

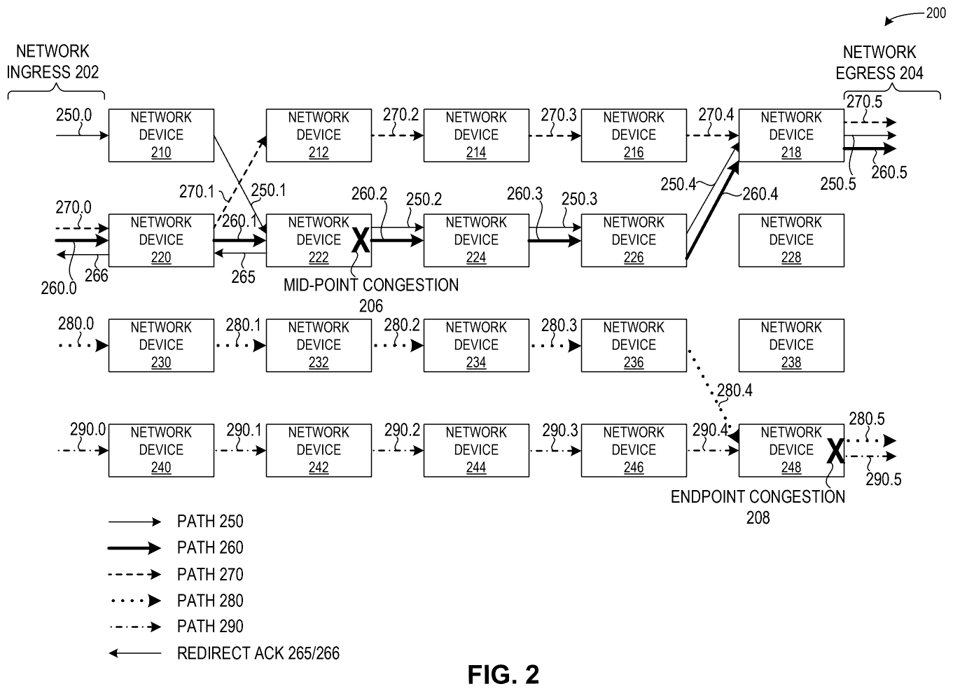

FIG. 2 illustrates an environment 200 which facilitates optimizing selection of flows to reroute, in accordance with an aspect of the present application. Environment 200 can include: ingress network devices 210, 220, 230, and 240; intermediate or mid-point network devices 212, 214, 216, 222, 224, 226, 232, 234, 236, 242, 244, and 246; and egress network devices 218, 228, 238, and 248. Environment 200 can be similar to network fabric 110 of FIG. 1 in that multiple paths may exist for data traveling from an ingress network device through one or more intermediate network devices to an egress network device. Data may be traveling through environment 200 via a plurality of paths, e.g.: a path 250 (indicated by a solid line) from a network ingress 202 to network device 210 (via a communication 250.1) to network device 222 (via a communication 250.1) to network device 224 (via a communication 250.2) to network device 226 (via a communication 250.3) to network device 218 (via a communication 250.4) and finally out to a network egress 204 (via a communication 250.5); a path 280 (indicated by a dotted line) from network ingress 202 to network device 230 (via a communication 280.0) to network device 232 (via a communication 280.1) to network device 234 (via a communication 280.2) to network device 236 (via a communication 280.3) to network device 248 (via a communication 280.4) and finally out to a network egress 204 (via a communication 280.5); and a path 290 (indicated by an alternating dotted and dashed line) from network ingress 202 to network device 240 (via a communication 290.0) to network device 242 (via a communication 290.1) to network device 244 (via a communication 290.2) to network device 246 (via a communication 290.3) to network device 248 (via a communication 290.4) and finally out to a network egress 204 (via a communication 290.5).

In addition, data may travel via a path 260 (indicated by a heavy solid line) from network ingress 202 to network device 220 (via a communication 260.0) to network device 222 (via a communication 260.1) to network device 224 (via a communication 260.2) to network device 226 (via a communication 260.3) to network device 218 (via a communication 260.4) and finally out to a network egress 204 (via a communication 260.5).

During operation, an intermediate network device may detect mid-point congestion and an egress network device may detect endpoint congestion when a packet for a flow is received. For example, when a packet for a flow on path 250 or 260 is received, network device 222 (operating as an intermediate network device) may detect a mid-point congestion 206 (indicated by a bold “X”) related to the flows originating from ingress network devices 210 and 220. When a packet for a flow on path 280 or 290 is received, network device 248 (operating as an egress network device) may detect an endpoint congestion 206 (indicated by a bold “X”) related to the flows originating from ingress network devices 230 and 240.

Because egress network device 248 detects the endpoint congestion (relating to the flows on paths 250 and 260 originating from network devices 230 and 240) upon the flow already reaching the egress of the network, rerouting those flows will not help those flows achieve improved performance. In such cases, the system may instead slow down the flows which contribute to the congestion at the ingress of the network (e.g., at 202).

In contrast, because the flows originating from network devices 210 and 220 have reached mid-point network device 222 and have not yet reached the egress of the network, rerouting those flows may result in improved performance. Each intermediate network device can receive flows and generate a load metric for each flow. As described above, the load metric may be based on a current load associated with a respective network device, e.g., a depth of an output buffer or queue on the respective network device. For example, network device 222 can generate a load metric for the flows originating from network devices 210 and 220. Network device 222 can determine that the load metric for the flow originating from network device 220 is greater than a particular load value. The particular load value can be a preconfigured or predetermined value. Thus, network device 222 can detect mid-point congestion 206. Upon detecting mid-point congestion 206, network device 222 can send a redirect ACK to ingress network device 220 (via a communication 265 to network device 220). In some aspects, network device 220 may be an intermediate network device, which can send the redirect ACK to another ingress network device in network ingress 202 (e.g., via a communication 266). Network device 220 (and depicted ingress network devices 210, 230, and 240) may thus perform functionality associated with both an intermediate network device and an endpoint network device (as described above in relation to switches 116 and 120 in FIG. 1).

Ingress network device 220 may receive the redirect ACK from intermediate network device 222 (via 265) indicating mid-point congestion 206 relating to the flow originating from network device 220 (on path 260). Ingress network device 220 may also receive other redirect ACKS from other intermediate network devices indicating mid-point congestion relating to other flows on other paths (not shown). Each redirect ACK can include the load metric for the corresponding flow. Ingress network device 220 may determine a probability of selecting each flow to be rerouted based on a set of rerouting conditions, as described above in relation to switch 120 of FIG. 1.

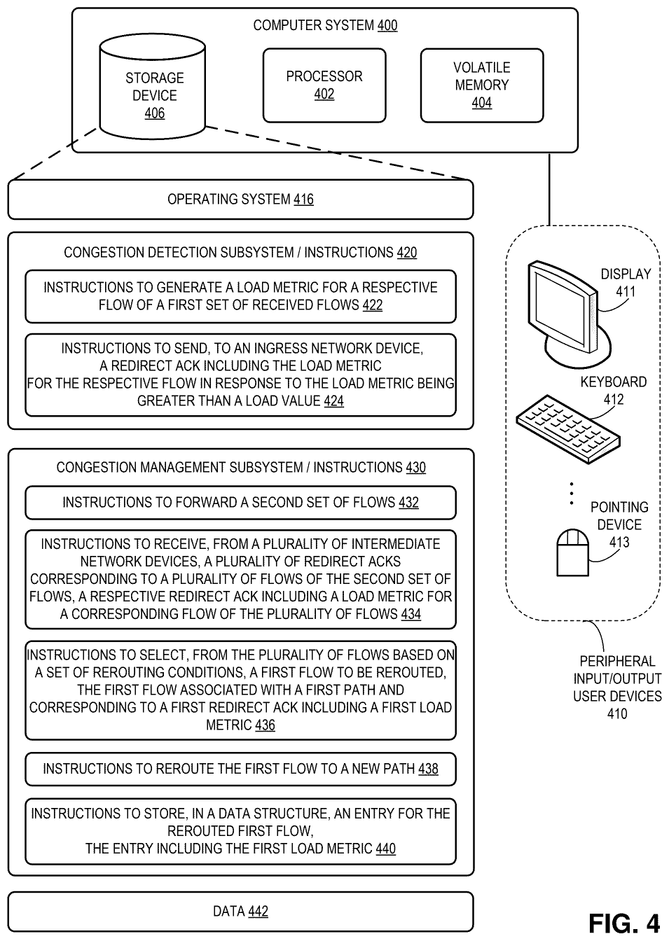

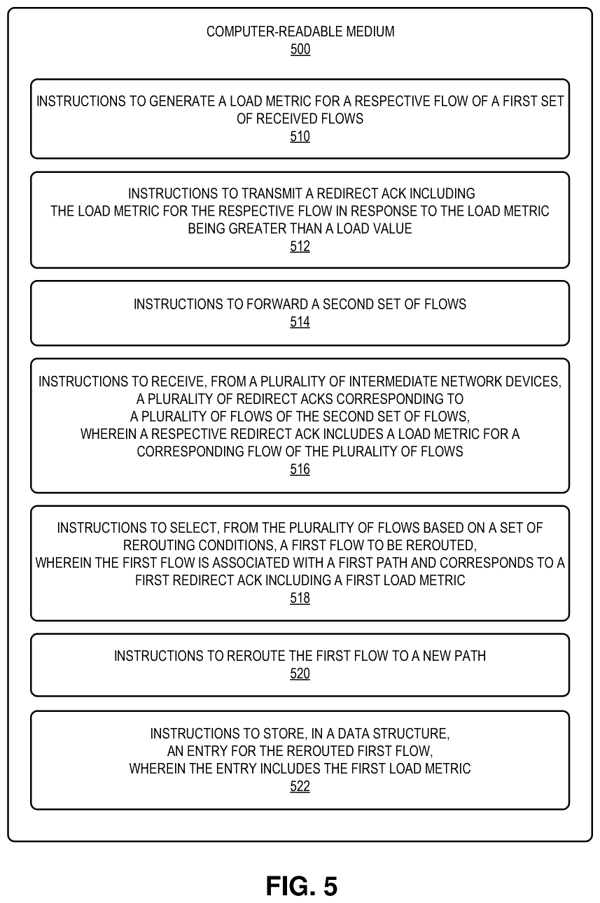

Based on the probability and rerouting conditions, ingress network device 220 may select, from those flows, the flow originating from network device 220 (on path 260) and can reroute that flow to a new path (path 270 as indicated by a dashed line), e.g., from network device 220 to network device 212 (via a communication 270.1) to network device 214 (via a communication 270.2) to network device 216 (via a communication 270.3) to network device 218 (via a communication 270.4) and finally out to a network egress 204 (via a communication 270.5). In some aspects, network device 220 may be an intermediate network device and can receive the rerouted data on the new path 270 from network ingress 202 (via a communication 270.0 as indicated by the dashed line). Thus, network device 220 may perform the operations described above in relation to both switch 120 (as an ingress network device) and switch 116 (as an intermediate network device) of FIG. 1. The operations performed as an ingress network device are further described below in relation to the flowcharts in FIGS. 3B, 3C, and 3D, congestion management subsystem/instructions 430 of FIG. 4, and instructions 514-522 of FIG. 5. The operations performed as an intermediate network device are further described below in relation to the flowchart in FIG. 3A, congestion detection subsystem/instructions 420 of FIG. 4, and instructions 510-514 of FIG. 5

FIG. 3A presents a flowchart 300 illustrating a method which facilitates optimizing selection of flows to reroute, including a network device operating as an intermediate network device, in accordance with an aspect of the present application. Traffic may be forwarded through a system or network fabric and travel through many network devices, e.g., from ingress network devices via intermediate network devices to egress network devices. A network device may include instructions, subsystems, units, logic, hardware, firmware, or software components which allow the network device to perform operations as an ingress network device, an intermediate network device, or an egress network device.

During operation, the system receives, by a network device operating as a first intermediate network device in a network fabric, a first set of flows (operation 302). For example, intermediate network device 222 in FIG. 2 can receive flows from communications 250.1 and 260.1. While only two communications or flows to intermediate network device 222 are depicted in FIG. 2, an intermediate network device may receive any number of flows, which can result in the first set of flows.

The system generates, by the network device operating as a first intermediate network device in the network fabric, a load metric for a respective flow of a first set of received flows (operation 304). The network device may generate the load metric based on a current load associated with the network device, as indicated by a depth of its output buffer representing an amount of data pending to be sent. The decision on whether or not to generate a redirect ACK may also be based on, e.g.: an ECA value which indicates a level or severity of congestion on the link; a size of a packet in a respective flow; a product of the load and the packet size; a current consumption of bandwidth associated with the network device; an amount of data pending in an input buffer of the network device; and any information received from a NIC or associated with a state of the respective flow. If the amount of data pending to be sent in the output buffer is greater than a predetermined threshold, the network device can determine that the load metric is greater than a load value, where this load value may be a predetermined threshold, an initial threshold, or another limit set or determined by the system or an administrative user associated with the system or network device.

If the load metric is greater than a load value (decision 306), the system sends, to a first ingress network device associated with the respective flow, a redirect acknowledgment (ACK) including the load metric for the respective flow in response to the load metric being greater than the load value (operation 308). For example, when a packet for a flow is received, intermediate network device 222 in FIG. 2 can detect mid-point congestion 206 (based on the generated load metric being greater than the load value) and can transmit a redirect ACK to ingress network device 220 (or another ingress network device in network ingress 202), as described above in relation to communication 265 of FIG. 2.

If the load metric is not greater than the load value (decision 306) (i.e., is less than or equal to the load value), the system refrains from sending the redirect ACK to the first ingress network device in response to the load metric being less than or equal to the load value (operation 310). Continuing with the example of intermediate network device 222 in FIG. 2, if intermediate network device 222 determines that the generated load metric is not greater than the load value, intermediate network device 222 can refrain from sending the redirect ACK (e.g., does not send communication 265). The operation continues at Label A of FIG. 3B.

FIG. 3B presents a flowchart 330 illustrating a method which facilitates optimizing selection of flows to reroute, including a network device operating as an ingress network device, in accordance with an aspect of the present application. During operation, the system forwards, by the network device operating as a second ingress network device in the network fabric, a second set of flows (operation 332). For example, any one of network devices 210, 220, 230, and 240 in FIG. 2 can operate as an ingress network device and may forward a second set of flows (which may be different from the first set of flows received by the intermediate network device in operation 302 of FIG. 3A). For ingress network device 220, the second set of flows may include the flow indicated by communications path 260 (including communications 260.1-260.5).

The system receives, from a plurality of intermediate network devices, a plurality of redirect ACKs corresponding to a plurality of flows of the second set of flows, wherein a respective redirect ACK includes a load metric for a corresponding flow of the plurality of flows (operation 334). As depicted in FIG. 2, ingress network device 220 may receive redirect ACK 265 (as generated and transmitted by intermediate network device 222 upon detecting mid-point congestion 206 when a packet of a flow is received). While not depicted in FIG. 2, ingress network device 220 may also receive other redirect ACKs generated and transmitted by other intermediate network devices upon detecting mid-point congestion for corresponding flows. Each redirect ACK can include the generated load metric for the corresponding flow.

The system selects, from the plurality of flows based on a set of rerouting conditions, a first flow to be rerouted, wherein the first flow is associated with a first path and corresponds to a first redirect ACK including a first load metric (operation 336). The set of rerouting conditions may be used to determine a probability of selecting a respective flow to be rerouted or to assign a ranking for the flows (e.g., an order in which the flows are to be selected for rerouting). The rerouting conditions may include, e.g.: an amount of time that has passed since a most recently rerouted flow; an amount of data pending to be sent in a respective flow of the plurality of flows; a comparison of the load metric of the respective flow of the plurality of flows to load metrics of other flows in the plurality of flows; a difference, if available, between load metrics included in redirect ACKs received corresponding to a same flow; and a ranked order of the plurality of flows

The system determines whether to pause the first flow prior to rerouting the first flow to a new path or to reroute the first flow to the new path (decision 338). For example, the system may determine to pause the first flow if a configuration is set to initiate a waiting period based on tracked pending ACKs, and the system may determine to reroute the first flow if the probability of the first flow being rerouted is greater than a threshold probability. If the system determines to pause the first flow prior to rerouting the first flow to the new path (decision 338), the operation continues at Label B of FIG. 3C. If the system determines to reroute the first flow to the new path (decision 338), the operation continues at Label C of FIG. 3D. The operation may continue from operation 336 to decision 338 to either one of Label B (pause) or Label C (reroute) concurrently for different ingress network devices or flows. In some aspects, the system may not perform decision 338 and instead continues from operation 336 to either one of Label B or Label C.

FIG. 3C presents a flowchart 340 illustrating a method which facilitates optimizing selection of flows to reroute, including pausing a flow which may be rerouted, in accordance with an aspect of the present application. During operation, the system pauses, by the network device operating as the second ingress network device, the first flow prior to rerouting the first flow to the new path (operation 342). In FIG. 2, ingress network device 220 may pause or stop data that is related to the flow of data (“first flow” via path 260) prior to rerouting that first flow to a new path.

The system waits until at least a predetermined number of pending ACKs associated with the first flow are received (operation 344). The system (i.e., the network device operating as the second network ingress network device, such as ingress network device 220 of FIG. 2) may track the number of pending ACKs which are received in response to sending packets of the first flow. Alternatively, the system may wait until the downstream flow has completed cleared of all packets, as indicated by returned ACKs representing the amount or quantity of data in the flow, rather than the number of packets needed to send this data. The system may or may not have a one-to-one mapping of returned ACKs to sent packets. The predetermined number of pending ACKs may be configured to account for packet loss and may be a specific number or a percentage. For example, ingress network device 220 may wait until at least twenty of the pending ACKs (or 80% or another threshold value) associated with the first flow of data (over path 260) are received or have been returned, indicating that the data associated with the pending ACKs has been successfully transmitted to or by the egress network device. In some aspects, ingress network device 220 may wait until almost all or all of the pending ACKs have been received.

If the predetermined number of pending ACKs is not received (decision 346), the operation returns to operation 344. If the predetermined number of pending ACKs is received (decision 346), the system determines whether the (same) first path is offered more than a predetermined number of times as the new path for the paused first flow which may be rerouted (decision 348).

If the (same) first path is not offered more than a predetermined number of times (e.g., 5) as the new path (decision 348), the operation continues at Label C of FIG. 3D. If the (same) first path is offered more than a predetermined number of times (e.g., 5) as the new path (decision 348), the system releases the first flow to continue being routed on the first path (operation 350). Subsequent to releasing the first flow to continue being routed on the (same) first path, the system refrains from rerouting the first flow on the new path (operation 352). For example, in FIG. 2, if the network device does not offer the same first path (path 260) more than five times, as the new path, the operation continues at Label C of FIG. 3D (i.e., rerouting the first flow to a different new path). If the network device offers the same first path (path 260) as the reroute or new path more than five times, the network device can (by tracking the offered path and number of times the path is offered) determine to release that first flow to continue being routed on the original path (path 260), i.e., the first path 260 over which packets received by network device 222 triggered the initially detected mid-point congestion (206)., and the network device can refrain from rerouting the flow (originally over path 260) on the new path (over path 270).

FIG. 3D presents a flowchart 360 illustrating a method which facilitates optimizing selection of flows to reroute, including rerouting a flow, in accordance with an aspect of the present application. During operation, the system reroutes, by the network device operating as the second ingress network device, the first flow to the new path (operation 362). For example, ingress network device 220 can reroute the first flow (over path 260) to a new path (over path 270 as indicated by the dashed lines), as described above in relation to FIG. 2.

The system stores, in a data structure by the network device operating as the second ingress network device, an entry for the rerouted first flow, wherein the entry includes the first load metric (operation 364). The network device can store an entry for the first flow which has been rerouted, including identifying information for the original flow (e.g., over path 260), identifying information for the new or rerouted path (e.g., over path 270), and first load metric information determined or generated by the network device related to the first flow.

The system receives a second redirect ACK corresponding to the rerouted first flow, wherein the second redirect ACK includes a second load metric (operation 366). For example, while not depicted in FIG. 2, ingress network device 220 may receive another redirect ACK (second redirect ACK) from another intermediate network device, e.g., intermediate network device 234. The second redirect ACK may also include identifying information for its corresponding original flow (second flow), identifying information for a new or rerouted path, and second load metric information determined or generated by intermediate network device 234 related to the second flow.

The system stores, in the entry for the rerouted first flow, the second load metric (operation 368). The data structure may be a table, list, array, or other manner of storing data and associated information. Thus, continuing with the example of ingress network device 220 in FIG. 2 in receiving both the first and second redirect ACKs and storing associated information, ingress network device 220 may store the second load metric in the same entry as the first load metric.

The system calculates a difference between the second load metric included in the second redirect ACK and the first load metric included in the first redirect ACK (operation 370). The network device operating as the second ingress network device may maintain the data structure and may also perform and store the calculation of the difference in the data structure entry for the rerouted first flow. The difference between the first load metric and the second load metric may be expressed in terms of, e.g.: a difference between ECA values; a difference between bandwidth consumptions; a difference between a number of bytes pending; and a difference based on how the first and second load metrics are calculated or measured.

The system adjusts a probability of selecting the first flow to be rerouted based on the difference (operation 372). For example, a small difference (such as less than a three percent difference in the measurements) may indicate that congestion has not improved much using the new or rerouted path. As a result, the first flow may be marked as a strong candidate to be selected for rerouting, i.e., the network device can increase the probability that the first flow is to selected for rerouting. In contrast, a large difference (such as greater than a 60% difference in the measurements) may indicate that congestion has improved significantly using the new or rerouted path. As a result, it may be less beneficial to reroute the first flow, and the network device may mark the first flow as a weak candidate to be selected for rerouting. The marking as a “strong” or “weak” candidate is provided for illustrative purposes only. Other categories or types may be used, including levels, ranges or windows of values, and a finite or bounded number of categories to be assigned to each candidate of the set of received flows.

Thus, by allowing mid-point network devices to generate a metric and send redirect ACKs under certain circumstances, and by allowing ingress network devices to receive multiple redirect ACKs and to make decisions on rerouting a flow based on various rerouting conditions (as described herein), the described aspects provide a system which can optimize the selection of flows to reroute based on congestion detected by mid-point network devices (mid-point congestion) and congestion managed by ingress network devices. Optimizing the selection of flows can result in improved performance and a more efficient overall system.

FIG. 4 illustrates a computer system 400 which facilitates optimizing selection of flows to reroute, in accordance with an aspect of the present application.

Computer system 400 includes a processor 402, a memory 404, and a storage device 406. Memory 404 may include a volatile memory (e.g., random access memory (RAM)) that serves as a managed memory and can be used to store one or more memory pools. Furthermore, computer system 400 may be coupled to peripheral I/O user devices 410 (e.g., a display device 411, a keyboard 412, and a pointing device 413).

Storage device 406 includes non-transitory computer-readable storage medium and stores an operating system 416, a congestion detection subsystem/instructions 420, a congestion management subsystem/instructions 430, and data 442. Computer system 400 may include fewer or more entities or instructions than those shown in FIG. 4.

Instructions 420 may include instructions 422 and 424, which when executed by computer system 400, can cause computer system 400 to perform methods and/or processes described in this disclosure, e.g., including computer system 400 operating as an intermediate network device. Specifically, computer system 400 may store instructions 422 to generate a load metric for a respective flow of a first set of received flows, as described above in relation to, e.g., switch 116 of FIG. 1 and operation 304 of FIG. 3A.

Computer system 400 may store instructions 424 to send, to an ingress network device, a redirect ACK including the load metric for the respective flow in response to the load metric being greater than a load value, as described above in relation to switches 118 and 120 of FIG. 1 and operation 308 of FIG. 3A.

Instructions 430 may also include instructions 432, 434, 436, 438, and 440, which when executed by computer system 400, can cause computer system 400 to perform methods and/or processes described in this disclosure, e.g., including computer system 400 operating as an ingress network device. Specifically, computer system 400 may store instructions 432 to forward a second set of flows, as described above, e.g., in relation to ingress network device 220 forwarding flows and operation 332 of FIG. 3B.

Computer system 400 may further store instructions 434 to receive, from a plurality of intermediate network devices, a plurality of redirect ACKs corresponding to a plurality of flows of the second set of flows, a respective redirect ACK including a load metric for a corresponding flow of the plurality of flows. Receiving multiple redirect ACKs which each include a load metric for a corresponding flow is described above in relation to ingress network device 220 of FIG. 2 and operation 334 of FIG. 3B.

Computer system 400 may store instructions 436 to select, from the plurality of flows based on a set of rerouting conditions, a first flow to be rerouted, the first flow associated with a first path and corresponding to a first redirect ACK including a first load metric. Selecting a flow to be rerouted may be based on a determined probability or a set of rerouting conditions, as described above in relation to ingress network device 220 of FIG. 2 and operation 336 of FIG. 3B.

Computer system 400 may store instructions 438 to reroute the first flow to a new path. Rerouting the first flow may occur subsequent to pausing the flow, waiting until a predetermined number of pending ACKs have been received, or determining that a same first path is offered a certain number of time as compared to a predetermined number, as described above in relation to operations 340-348 in FIG. 3C and operation 352 of FIG. 3D.

Computer system 400 may store instructions 440 to store, in a data structure, an entry for the rerouted first flow, the entry including the first load metric, as described above in relation to operation 364 of FIG. 3D.

Instructions 420 and 430 may include more instructions than those shown in FIG. 4. For example, instructions 420 and 430 may include instructions for executing the operations described above in relation to: the environments of FIGS. 1 and 2; the operations depicted in the flowcharts of FIGS. 3A-D; and instructions 510-522 of CRM 500 in FIG. 5.

Data 442 can include any data that is required as input or that is generated as output by the methods, operations, communications, and/or processes described in this disclosure. Specifically, data 442 can store at least: a load metric; a flow; data of a flow; a load value; a predetermined value; a result of a comparison of a load metric to a load value; a redirect ACK; a redirect ACK corresponding to a flow and including a load metric; a plurality of flows; a selected flow; a first path; an original path; a same path; a new path; a path for rerouting a flow; a data structure; an entry in a data structure; a difference between load metrics; a probability of selecting a flow to be rerouted; an adjusted probability; a condition; a rerouting condition; an amount of time; an amount of data; a comparison between load metrics; a difference between load metrics; a ranked order; a current load; a size of a packet; a product of the load and the packet size; a bandwidth consumption; an amount of data pending in an output or input buffer; information received from a NIC or associated with a state of a flow; a decision of whether or not to send a redirect ACK; and a predetermined or preconfigured threshold.

FIG. 5 illustrates a computer-readable medium (CRM) 500 which facilitates optimizing selection of flows to reroute, in accordance with an aspect of the present application. CRM 500 can be a non-transitory computer-readable medium or device storing instructions that when executed by a computer or processor cause the computer or processor to perform a method. CRM 500 may store instructions 510 to generate a load metric for a respective flow of a first set of received flows, as described above in relation to, e.g., switches 116 and 118 of FIG. 1 and operation 304 of FIG. 3A.

CRM 500 may store instructions 512 to transmit a redirect ACK including the load metric for the respective flow in response to the load metric being greater than a load value, as described above in relation to switches 118 and 120 of FIG. 1 and operation 308 of FIG. 3A.

CRM 500 may store instructions 514 to forward a second set of flows, as described above, e.g., in relation to ingress network device 220 forwarding flows in FIG. 2 and operation 332 of FIG. 3B.

CRM 500 may store instructions 516 to receive, from a plurality of intermediate network devices, a plurality of redirect ACKs corresponding to a plurality of flows of the second set of flows, wherein a respective redirect ACK includes a load metric for a corresponding flow of the plurality of flows. Receiving multiple redirect ACKs which each include a load metric for a corresponding flow is described above in relation to ingress network device 220 of FIG. 2 and operation 334 of FIG. 3B.

CRM 500 may store instructions 518 to select, from the plurality of flows based on a set of rerouting conditions, a first flow to be rerouted, wherein the first flow is associated with a first path and corresponds to a first redirect ACK including a first load metric. Selecting the first flow to be rerouted (i.e., the “candidate flows”) may be based on determining a probability for each flow or on one or more rerouting conditions, including the ones provided as examples above in relation to ingress network device 220 of FIG. 2 and operation 336 of FIG. 3B.

CRM 500 may store instructions 520 to reroute the first flow to a new path, as described above in relation to ingress network device 220 of FIG. 2 (depicting rerouting to the path via 271-285, indicated by the dashed line) and operation 336 of FIG. 3B.

CRM 500 may store instructions 522 to store, in a data structure, an entry for the rerouted first flow, wherein the entry includes the first load metric, as described above in relation to operation 364 of FIG. 3D.

CRM 500 may include more instructions than those shown in FIG. 5. For example, CRM 500 may also store instructions for executing the operations described above in relation to: the environments of FIGS. 1 and 2; the operations depicted in the flowcharts of FIGS. 3A-D; and instructions 420 and 430 of computer system 400 in FIG. 4.

The term “network device” refers to any device, component, or computing entity which can provide a communication pipeline for packets sent from a “processing node” or an “endpoint node. ” A processing or endpoint node can refer to a device, component, or hardware component which can operate as a source or a destination of data, including e.g., a control packet or a data packet. A network device may include an ingress network device, an intermediate or mid-point network device, or an egress or endpoint network device. An example of a network device may be a switch, as described above in relation to FIG. 1. A processing node or endpoint node can include an ingress node (which is an endpoint for data returned from a request) or an egress node (which is an endpoint for data sent from a request). Additionally, a network device may operate as or perform the functionality described herein of an ingress network device, an intermediate network device, or an egress network device.

In general, the disclosed aspects provide a computing system, a method, and a computer-readable medium which facilitate optimizing selection of flows to reroute. The computing system operates in a network fabric including ingress network devices, intermediate network devices, and egress network devices. The computing system comprises a processor and a storage device storing congestion detection and congestion management instructions (also referred to as subsystems) which when executed by the processor are to perform the following operations. The congestion detection subsystem may include instructions to: generate a load metric for a respective flow of a first set of received flows; and send, to an ingress network device, a redirect acknowledgment (ACK) including the load metric for the respective flow in response to the load metric being greater than a load value. The congestion management subsystem may include instructions to: receive a first redirect ACK corresponding to a first flow; and determine, based on a set of rerouting conditions, whether to select the first flow to be rerouted. The computing system may further include instructions to perform the operations described herein, including in relation to: the environments of FIGS. 1 and 2; the operations depicted in the flowcharts of FIGS. 3A-D; and the instructions of CRM 500 in FIG. 5.

In a variation on this aspect, the congestion management instructions are further to: forward a second set of flows including the first flow, wherein the first flow is associated with a first path, and wherein the first redirect ACK indicates a first load metric; receive, from a plurality of intermediate network devices, a plurality of redirect ACKs corresponding to a plurality of flows of the second set of flows, wherein the plurality of redirect ACKs includes the first redirect ACK, and wherein a respective redirect ACK includes a load metric for a corresponding flow of the plurality of flows; determine to select, from the plurality of flows based on the set of rerouting conditions, the first flow to be rerouted; and reroute the first flow to a new path. The congestion management instructions are further to: store, in a data structure, an entry for the rerouted first flow, the entry including the first load metric; receive a second redirect ACK corresponding to the rerouted first flow, the second redirect ACK including a second load metric; and store, in the entry for the rerouted first flow, the second load metric.

In a further variation on this aspect, the congestion management instructions are further to determine a difference between the second load metric included in the second redirect ACK and the first load metric included in the first redirect ACK. The congestion management instructions are further to adjust a probability of selecting the first flow to be rerouted based on the difference.

In another variation on this aspect, the set of rerouting conditions are associated with a probability of a respective flow from the plurality of flows being selected to be rerouted.

In a further variation, the set of rerouting conditions comprises at least one of: an amount of time that has passed since a most recently rerouted flow; an amount of data pending to be sent in a respective flow of the plurality of flows; a comparison of the load metric of the respective flow of the plurality of flows to load metrics of other flows in the plurality of flows; a difference, if available, between load metrics included in redirect ACKs received corresponding to a same flow; or a ranked order of the plurality of flows.

In a further variation, the generated load metric for the respective flow of the first set of flows in the congestion detection subsystem and the load metric for the corresponding flow of the plurality of flows in the congestion management subsystem are based on at least one of: a load associated with the congestion detection subsystem or the congestion management subsystem expressed as an explicit congestion avoidance (ECA) value; or a size of a packet in the respective flow of the first set of flows or in the corresponding flow of the plurality of flows.

In a further variation, the generated load metric for the respective flow of the first set of flows in the congestion detection subsystem and the load metric for the corresponding flow of the plurality of flows in the congestion management subsystem comprise: a product of the load and the packet size for the respective flow in the congestion detection subsystem or the congestion management subsystem.

In a further variation, the generated load metric for the respective flow of the first set of flows in the congestion detection subsystem and the load metric for the corresponding flow of the plurality of flows in the congestion management subsystem are based on at least one of: bandwidth consumption associated with the congestion detection subsystem or the congestion management subsystem; an amount of data pending in an input buffer associated with the congestion detection subsystem or the congestion management subsystem; information received from a network interface controller (NIC) and associated with an amount of data pending to be processed by the congestion detection subsystem or the congestion management subsystem; or information associated with a state of the respective flow of the first set of flows in the congestion detection subsystem or the corresponding flow of the plurality of flows in the congestion management subsystem.

In a further variation, the congestion management instructions are to, prior to rerouting the first flow to a new path, pause the first flow. The congestion management instructions are further to wait until at least a predetermined number of pending ACKs associated with the first flow are received. The congestion management instructions are further to, in response to waiting until the predetermined number of pending ACKs are received and in response to being offered the first path more than a predetermined number of times: release the first flow to continue being routed on the first path; and refrain from rerouting the first path.

In a further variation, the congestion detection instructions are to refrain from sending, to the ingress network device, the redirect ACK in response to the load metric being less than the load value.

In a further variation, the congestion detection instructions are further to compare the load metric to the load value in response to the load metric being greater than a predetermined threshold.

In a further variation, the load value comprises a randomly generated number.

In another aspect, a computer-implemented method may include various operations performed by, e.g., a system. The system generates, by a network device operating as a first intermediate network device in a network fabric, a load metric for a respective flow of a first set of received flows. The system sends, to a first ingress network device associated with the respective flow, a redirect acknowledgment (ACK) including the load metric for the respective flow in response to the load metric being greater than a load value. The system refrains from sending the redirect ACK to the first ingress network device in response to the load metric being less than the load value. The system forwards, by the network device operating as a second ingress network device in the network fabric, a second set of flows. The system receives, from a plurality of intermediate network devices, a plurality of redirect ACKs corresponding to a plurality of flows of the second set of flows, wherein a respective redirect ACK includes a load metric for a corresponding flow of the plurality of flows. The system selects, from the plurality of flows based on a set of rerouting conditions, a first flow to be rerouted, wherein the first flow is associated with a first path and corresponds to a first redirect ACK including a first load metric. The system reroutes the first flow to a new path. The method may include additional operations, including in relation to: the environments of FIGS. 1 and 2; the operations depicted in the flowcharts of FIGS. 3A-D; instructions 420 and 430 of computing system 400 in FIG. 4; and instructions 510-522 of CRM 500 in FIG. 5.

In another aspect, a non-transitory computer-readable storage medium (or CRM) stores instructions to generate a load metric for a respective flow of a first set of received flows. The instructions are further to transmit a redirect acknowledgment (ACK) including the load metric for the respective flow in response to the load metric being greater than a load value. The instructions are further to forward a second set of flows. The instructions are further to receive, from a plurality of intermediate network devices, a plurality of redirect ACKs corresponding to a plurality of flows of the second set of flows, wherein a respective redirect ACK includes a load metric for a corresponding flow of the plurality of flows. The instructions are further to select, from the plurality of flows based on a set of rerouting conditions, a first flow to be rerouted, wherein the first flow is associated with a first path and corresponds to a first redirect ACK including a first load metric. The instructions are further to reroute the first flow to a new path. The instructions are further to store, in a data structure, an entry for the rerouted first flow, wherein the entry includes the first load metric. The CRM may also store instructions for executing the operations described above in relation to: the environments of FIGS. 1 and 2; the operations depicted in the flowcharts of FIGS. 3A-D; instructions 420 and 430 of computer system 400 in FIG. 4; and instructions 510-522 of CRM 500 in FIG. 5.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art.

Additionally, the above disclosure is not intended to limit the aspects described herein. The scope of the aspects described herein is defined by the appended claims.

What is claimed is:

1. A computing system operating in a network fabric including ingress network devices and intermediate network devices, the computing system comprising:
a congestion detection subsystem and a congestion management subsystem;
the congestion detection subsystem to:
generate a load metric for a respective flow of a first set of received flows; and
send, to an ingress network device, a redirect acknowledgment (ACK) including the load metric for the respective flow in response to the load metric being greater than a load value; and
the congestion management subsystem to:
receive a first redirect ACK corresponding to a first flow; and
determine, based on a set of rerouting conditions, whether to select the first flow to be rerouted.

2. The computing system of claim 1, wherein the congestion management subsystem is further to:
forward a second set of flows including the first flow, wherein the first flow is associated with a first path, and wherein the first redirect ACK indicates a first load metric;
receive, from a plurality of intermediate network devices, a plurality of redirect ACKs corresponding to a plurality of flows of the second set of flows, wherein the plurality of redirect ACKs includes the first redirect ACK, and wherein a respective redirect ACK includes a load metric for a corresponding flow of the plurality of flows;
determine to select, from the plurality of flows based on the set of rerouting conditions, the first flow to be rerouted;
reroute the first flow to a new path;
store, in a data structure, an entry for the rerouted first flow, the entry including the first load metric;
receive a second redirect ACK corresponding to the rerouted first flow, the second redirect ACK including a second load metric; and
store, in the entry for the rerouted first flow, the second load metric.

3. The computing system of claim 2, wherein the congestion management
subsystem is further to:
determine a difference between the second load metric included in the second redirect ACK and the first load metric included in the first redirect ACK; and
adjust a probability of selecting the first flow to be rerouted based on the difference.

4. The computing system of claim 2,
wherein the set of rerouting conditions are associated with a probability of a respective flow from the plurality of flows being selected to be rerouted.

5. The computing system of claim 2, wherein the set of rerouting conditions comprises at least one of:
an amount of time that has passed since a most recently rerouted flow;
an amount of data pending to be sent in a respective flow of the plurality of flows;
a comparison of the load metric of the respective flow of the plurality of flows to load metrics of other flows in the plurality of flows;
a difference, if available, between load metrics included in redirect ACKs received corresponding to a same flow; or
a ranked order of the plurality of flows.

6. The computing system of claim 2, wherein the generated load metric for the respective flow of the first set of flows in the congestion detection subsystem and the load metric for the corresponding flow of the plurality of flows in the congestion management subsystem are based on at least one of:
a load associated with the congestion detection subsystem or the congestion management subsystem expressed as an explicit congestion avoidance (ECA) value; or
a size of a packet in the respective flow of the first set of flows or in the corresponding flow of the plurality of flows.

7. The computing system of claim 6, wherein the generated load metric for the respective flow of the first set of flows in the congestion detection subsystem and the load metric for the corresponding flow of the plurality of flows in the congestion management subsystem comprise:
a product of the load and the packet size for the respective flow in the congestion detection subsystem or the congestion management subsystem.

8. The computing system of claim 2, wherein the generated load metric for the respective flow of the first set of flows in the congestion detection subsystem and the load metric for the corresponding flow of the plurality of flows in the congestion management subsystem are based on at least one of:
bandwidth consumption associated with the congestion detection subsystem or the congestion management subsystem;
an amount of data pending in an input buffer associated with the congestion detection subsystem or the congestion management subsystem;
information received from a network interface controller (NIC) and associated with an amount of data pending to be processed by the congestion detection subsystem or the congestion management subsystem; or
information associated with a state of the respective flow of the first set of flows in the congestion detection subsystem or the corresponding flow of the plurality of flows in the congestion management subsystem.

9. The computing system of claim 2, wherein the congestion management subsystem is further to:
prior to rerouting the first flow to a new path, pause the first flow;
wait until at least a predetermined number of pending ACKs associated with the first flow are received; and
in response to waiting until the predetermined number of pending ACKs are received and in response to being offered the first path more than a predetermined number of times:
release the first flow to continue being routed on the first path; and
refrain from rerouting the first path.

10. The computing system of claim 1, wherein the congestion detection subsystem is further to:
refrain from sending, to the ingress network device, the redirect ACK in response to the load metric being less than the load value.

11. The computing system of claim 1, wherein the congestion detection subsystem is further to:
compare the load metric to the load value in response to the load metric being greater than a predetermined threshold.

12. The computing system of claim 1, wherein the load value comprises a randomly generated number.

13. A computer-implemented method, comprising:
generating, by a network device operating as a first intermediate network device in a network fabric, a load metric for a respective flow of a first set of received flows;
sending, to a first ingress network device associated with the respective flow, a redirect acknowledgment (ACK) including the load metric for the respective flow in response to the load metric being greater than a load value;
refraining from sending the redirect ACK to the first ingress network device in response to the load metric being less than the load value;
receiving a first redirect ACK corresponding to a first flow; and
determining, based on a set of rerouting conditions, whether to select the first flow to be rerouted.

14. The computer-implemented method of claim 13, further comprising:
forwarding a second set of flows including the first flow, wherein the first flow is associated with a first path, and wherein the first redirect ACK indicates a first load metric;
receiving, from a plurality of intermediate network devices, a plurality of redirect ACKs corresponding to a plurality of flows of the second set of flows, wherein the plurality of redirect ACKs includes the first redirect ACK, and wherein a respective redirect ACK includes a load metric for a corresponding flow of the plurality of flows;
determining to select, from the plurality of flows based on the set of rerouting conditions, the first flow to be rerouted; and
rerouting the first flow to a new path.

15. The computer-implemented method of claim 14, further comprising:
storing, in a data structure by the network device operating as the second ingress network device, an entry for the rerouted first flow,
wherein the entry includes the first load metric;
receiving a second redirect ACK corresponding to the rerouted first flow,
wherein the second redirect ACK includes a second load metric;
storing, in the entry for the rerouted first flow, the second load metric;
calculating a difference between the second load metric included in the second redirect ACK and the first load metric included in the first redirect ACK; and
adjusting a probability of selecting the first flow to be rerouted based on the difference.

16. The computer-implemented method of claim 14,
wherein the set of rerouting conditions are associated with a probability of a respective flow from the plurality of flows being selected to be rerouted, and
wherein the set of rerouting conditions comprises at least one of:
an amount of time that has passed since a most recently rerouted flow;
an amount of data pending to be sent in the respective flow of the plurality of flows;
a comparison of the load metric of the respective flow of the plurality of flows to load metrics of other flows in the plurality of flows;
a difference, if available, between load metrics included in redirect ACKs received corresponding to a same flow; or
an ordered list comprising the plurality of flows.

17. The computer-implemented method of claim 14,
wherein the generated load metric for the respective flow of the first set of flows and the load metric for the corresponding flow of the plurality of flows are based on at least one of:
a load associated with the respective flow of the first set of flows or the corresponding flow of the plurality of flows expressed as an explicit congestion avoidance (ECA) value; or
a size of a packet in the respective flow of the first set of flows or in the corresponding flow of the plurality of flows.

18. The computer-implemented method of claim 14,
wherein the generated load metric for the respective flow of the first set of flows and the load metric for the corresponding flow of the plurality of flows are based on at least one of:
bandwidth consumption associated with the network device operating as the first intermediate network device or as the second ingress network device;
an amount of data pending in an input buffer associated with the network device operating as the first intermediate network device or as the second ingress network device;
information received from a network interface controller (NIC) and associated with an amount of data pending to be processed by the network device operating as the first intermediate network device or as the second ingress network device; or
information associated with a state of the respective flow of the first set of flows or the corresponding flow of the plurality of flows.

19. The computer-implemented method of claim 14, further comprising:
pausing, by the network device operating as the second ingress network device, the first flow prior to rerouting the first flow to the new path;
waiting until at least a predetermined number of pending ACKs associated with the first flow are received; and
in response to waiting until the predetermined number of pending ACKs are received and in response to being offered the first path more than a predetermined number of times:
releasing the first flow to continue being routed on the first path; and
refraining from rerouting the first path.

20. A non-transitory computer-readable medium storing instructions to:
generate a load metric for a respective flow of a first set of received flows;
transmit a redirect acknowledgment (ACK) including the load metric for the respective flow in response to the load metric being greater than a load value;
forward a second set of flows;
receive, from a plurality of intermediate network devices, a plurality of redirect ACKs corresponding to a plurality of flows of the second set of flows,
wherein a respective redirect ACK includes a load metric for a corresponding flow of the plurality of flows;
select, from the plurality of flows based on a set of rerouting conditions, a first flow to be rerouted,
wherein the first flow is associated with a first path and corresponds to a first redirect ACK including a first load metric;
reroute the first flow to a new path; and
store, in a data structure, an entry for the rerouted first flow, wherein the entry includes the first load metric.
